(19) United States
(12) Patent Application Publication
(10) Pub. No.: US 2003/0134537 A1
(43) Pub. Date: Jul. 17, 2003

(54) Multiple mobile power socket

(76) Inventors: Christain Pio Pedulla, Milano (IT); Gianfilippo Pagliacci, Milano (IT); Egidio Motta, Milano (IT); Paolo Piazzolla, Milano (IT)

Correspondence Address: YOUNG & THOMPSON, 745 SOUTH 23RD STREET 2ND FLOOR, ARLINGTON, VA, 22202

(21) Appl. No.: 10/311,536

(22) PCT Filed: Jun. 11, 2001
(86) PCT No.: PCT/IB01/01016

(51) Int. Cl. H01R 13/60

(52) U.S. Cl. 439/535

(57) ABSTRACT

A multiple socket comprises a plurality of individual electric outlets (S, I) which are housed in a support (1) provided with a cable (C) and plug (P) for supplying electric power to said outlets (S, I). Said support (1) consists of several elements (2) which are hinged on the same axis (a), each element (2) being freely rotatable with respect to the adjacent elements (2). Each of said elements (2) houses at least one, preferably two opposite, and up to four of said individual electric outlets (S, I).

The present invention relates to a multiple mobile power socket (simply referred as “multiple socket” in the following) which is used to supply electric power to a plurality of electric appliances placed in the same location.

As well known to skilled men in the field of electric accessories, the use of multiple sockets has increased considerably in recent years in keeping with the increasing use, among consumers, of series of interconnected appliances placed in a single location, but each requiring a separate power supply.

Typical examples of these series of interconnected electric appliances are, for example, audio-visual reproduction systems and working seats based on computers (so-called “workstations”). Each of these systems in fact consists of a basic apparatus (for example a personal computer) and one or more peripheral units (for example printers, scanners, telephones, faxes, tape units, CD player/recording units, modems and the like) which increase the functionalities and capacities of the basic apparatus to which they are connected. These connections, however, normally involve only the logic functions of the various appliances, while the electric supply is separate for each of them, so as to limit the power consumption to only the appliance which is actually used.

Multiple sockets have become widespread precisely in response to this requirement for simultaneous powering of several adjacent appliances and solve the problems of electric safety, stability and aesthetic appearance associated with so-called “triple” plugs which were previously used, in some cases in a “cascade” arrangement on top of each other, directly plugged into the wall sockets.

The multiple sockets currently used normally have a series of 4 to 6 outlets—partly of the “Schuko” type, i.e. round and with a bilateral earthing contact, and partly of the Italian type, i.e. rectangular with a central earthing point, or still other further outlet types—which are varyingly arranged in a single housing so as to allow optimum use of the multiple socket, depending on the different forms of plug with which the electric appliances to be powered are equipped.

In recent years, however, precisely the form of these plugs has given rise to a new problem which makes the use of multiple sockets of the known type described above less efficient. Reference is here made to the fact that an increasing amount of electric appliances is powered nowadays at a low voltage and the transformer which converts the mains voltage into the operating voltage is provided right next to the plug, which therefore has a typical parallelepiped shape, of considerable size, which is well-known to any one who is vaguely familiar with electric appliances. The power supply units for recharging a whole series of portable electric devices, i.e. electric torches, mechanical tools, mobile phones and the like, the use of which is continuously and constantly increasing, are also equipped with the same type of plug/transformer.

The overall dimensions of the abovementioned plug/transformers are obviously much larger than those of normal plugs, and more particularly equivalent to about that of two “Schuko” plugs arranged alongside each other, such that when said plug transformers are inserted into a conventional multiple socket, the number of appliances which can be powered by the same is substantially halved. In order to be able to power the same number of appliances, it is therefore necessary to double the number of multiple sockets, with the obvious result that an inextricable jumble of electric cables is formed in the vicinity of the series of appliances being powered, which, in addition to being aesthetically unpleasing, also hinders proper cleaning of the area.

Another drawback of conventional multiple sockets also arises from their usual positioning on the floor. In this position, in fact, in addition to the abovementioned problems connected with aesthetics and cleaning, the sockets are also not easily accessible to users, for plugging-in and removal of the plugs. Although it is true that said sockets are normally provided with holes for fixing to work surfaces or to the wall, it is also true that this operation not only involves a minimum degree of complexity—at such extent that in practice it is nearly always performed only by professional persons—but also results in a final aesthetic appearance which, in a domestic environment, is never particularly pleasing.

The object of the present invention is therefore that of providing a new type of multiple socket which overcomes the drawbacks of multiple sockets of the known type, allowing each individual socket outlet to be always used, independently of the overall dimensions of the plug or plug/transformer which is connected thereto.

Another object of the present invention is to provide a multiple socket which may be placed in a convenient and practical position, other than the conventional position on the floor, so as to allow an ordered arrangement of the electric cables, easier access to the multiple socket by the user and easier cleaning of the area.

These objects are achieved, according to the present invention, by means of a multiple socket, of the type comprising a plurality of individual electric outlets which are housed in a single support provided with a cable and plug for supplying electric power to said outlets, characterized in that said support consists of several elements which are hinged on the same axis, each element being freely rotatable with respect to the adjacent elements and in that each of said elements houses at least one of said individual electric outlets.

In a preferred embodiment, said axis passes along an internal, and preferably central, position of said elements and said individual electric outlets are housed at the sides of said elements which lie parallel or substantially parallel to said axis.

In a second embodiment, said axis passes along a peripheral position of said elements and said individual electric outlets are arranged at the sides of said elements which lie parallel and/or perpendicular, or substantially so, to said axis.

Further features and advantages of the present invention will emerge more clearly, however, from the following detailed description of certain preferred embodiments thereof, illustrated in the accompanying drawings in which:

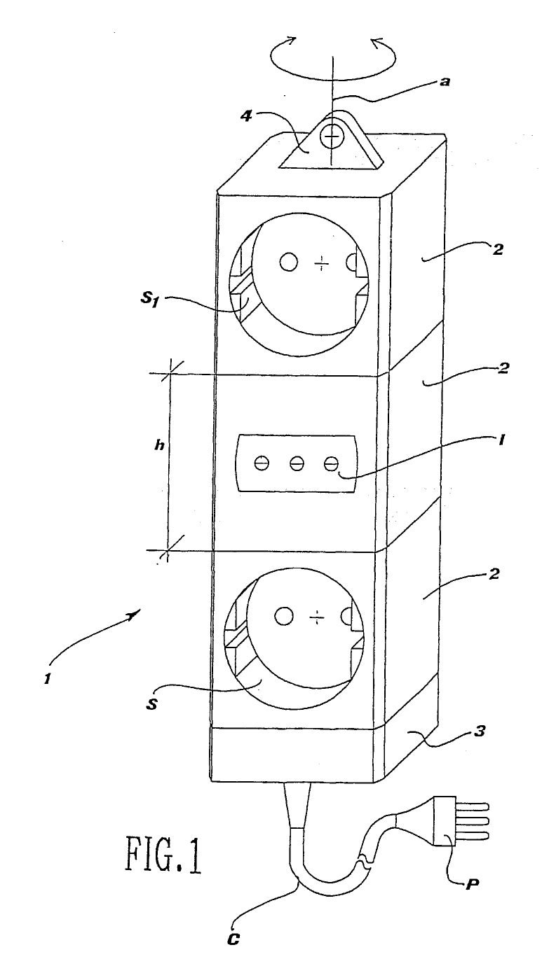

FIG. 1 is a schematic axonometric view of a multiple mobile power socket, according to a first embodiment of the present invention, in the “open” position;

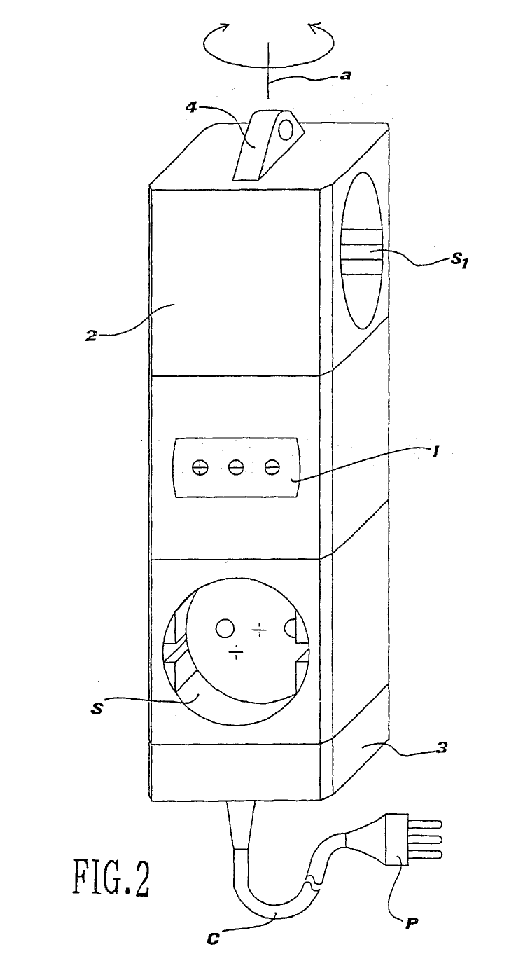

FIG. 2 is a schematic axonometric view similar to that of FIG. 1 and showing one of the elements of the multiple socket rotated through 90°;

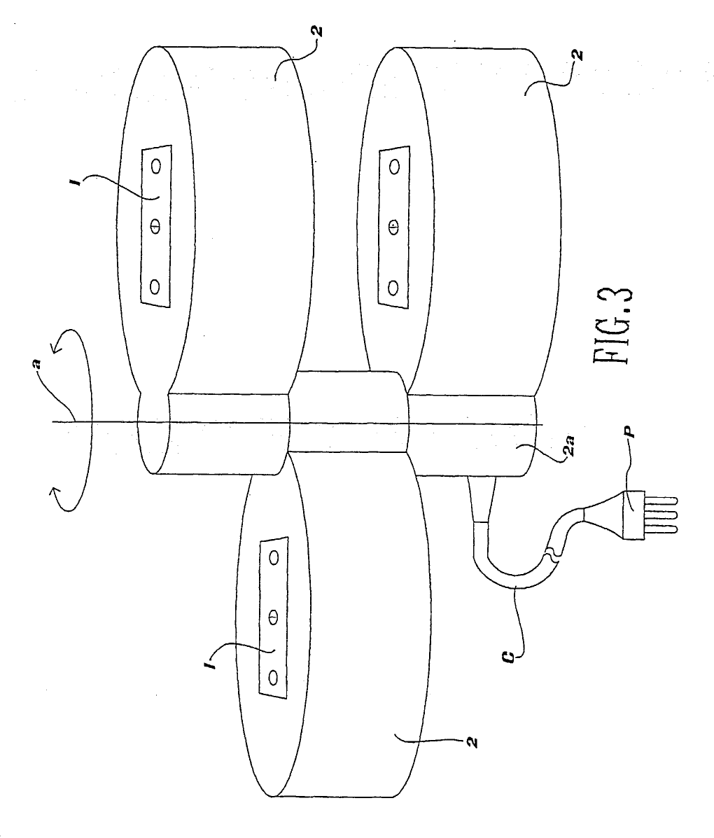

FIG. 3 is a schematic axonometric view of a multiple socket, according to a second embodiment of the present invention.

With reference to FIG. 1, it can be seen that the multiple socket according to the present invention consists of a parallelepiped-shaped body 1 formed by several adjacent elements 2, each of which is substantially cube-shaped. In particular the two sides of each element 2 which in FIG. 1 lie horizontally preferably have the same length and width, while the height h of the element 2 may vary depending on the type of outlet—i.e. Italian I or “Schuko” S—which is housed in the element 2. The external shape of the elements 2 may in any case be chosen as required, also taking into account any desirable aesthetic design of the multiple socket.

As mentioned in the introductory part, each element 2 is free to rotate, with respect to the adjacent elements, about a single axis a which, in this embodiment, passes centrally through the elements 2 and, as far as concerns its structure, for example consists of a hollow shaft (not shown) which co-operates with corresponding circular seats provided inside each element 2.

Each element 2 may house a single or, preferably, two opposite outlets S/I and the electric power supply to said outlets may be provided in any manner within the competence of a person skilled in the art, this power supply system not having any limiting effect on the invention. According to a practical and economical method of supplying the electric power to the different outlets S/I, the electric power reaches, via the plug P and the flexible cable C, a first service element 3 of limited height in which a current distributor, for example of the bar type, is housed. A set of three flexible cables departs from this distributor and supplies each outlet S/I or each pair of outlets S/I in the same element, passing inside the aforementioned central hollow shaft. Special travel stops prevent the elements 2 from being able to rotate more than +/−90° with respect to the position shown in FIG. 1, thus preventing the flexible cables from becoming twisted and damaged.

Finally, the multiple socket according to the present invention is provided with a hooking device 4 at the end opposite to that where the cable C is attached, so that the multiple socket may be fastened underneath a work surface, thus helping to keep the place tidy and thereby making the power socket unit easily accessible for the user and making the floor easy to clean, since it is no longer occupied by the multiple socket and by the cables connected to the same. The hooking device 4 shown in FIG. 1 has a closed shape, but it is obviously possible to envisage other types of hooks, both closed or open ones, suitable for any different requirement, such as, in a preferred manner, a C-shaped hook with elongated arms which may be inserted and elastically clamped onto the edge of a work surface—in the manner of clips used for fastening towels—without the need to fix a bracket to said surface beforehand.

The extraordinary simplicity and efficiency of use of the multiple socket according to the present invention should be now entirely evident. In fact, assuming that a plug/transformer of the abovementioned type is to be inserted into the top outlet S₁ of the multiple socket (FIG. 1), it would certainly cover the adjacent outlet I with its transformer body; this outlet should be therefore unusable. In the multiple socket according to this invention it is instead sufficient for the user to rotate by 90° the element 2 corresponding to the outlet S₁, bringing it into the position shown in FIG. 2; the plug/transformer plugged into the outlet S₁ in this rotated position of the element 2 so extends its transformer portion above the side of the underlying element 2 which is devoid of outlets, thus making the outlet I in the adjacent element 2, perfectly accessible for another plug.

It is therefore obvious that in this way it is possible to use all the outlets of the multiple socket according to the present invention, independently of the overall dimensions of the plugs which are inserted therein. Moreover if two opposite outlets are provided for each element 2, the total capacity of the multiple socket according to the present invention is even doubled, while maintaining substantially the same overall dimensions of the multiple socket 1, compared to a multiple socket according to the known art.

A second embodiment of the multiple socket according to the present invention is illustrated in FIG. 3. In this case the axis a about which the individual elements rotate is located in a peripheral position with respect to the said elements, such that the elements may be rotated in staggered angular positions so as to avoid the said elements 2 being arranged at a short distance above one other. This second embodiment is particularly suitable when the plugs are of the type in which the supply cable is connected to the plug at a right angle in respect of the plugging-in direction.

In this second embodiment of the multiple socket too, each element 2 may house one or two opposite outlets and in this case the outlet housing surface may also be perpendicular, or substantially perpendicular, to the axis a, as illustrated in FIG. 3, as well as parallel to said axis as already shown in the first embodiment. In this second embodiment it is also possible to provide up to four outlets in each element 2—located opposite each other in pairs at surfaces parallel and respectively perpendicular to the axis a—thus further increasing the capacity of the multiple socket.

A possible shape of the elements 2, in this second embodiment, is the one shown in FIG. 3 and comprises a cylindrical body of larger diameter housing the outlets I and a peripheral cylindrical body 2a having a much smaller diameter, wherein the pin which forms the axis a is incorporated. The axis a in this case is substantially tangential to the side surface of the cylindrical body of larger diameter and parallel to the generatrices thereof.

The electric connections to the different outlets S/I may be provided in a manner as described with regard to the first embodiment, or using any other system known to specialists in this field, without thereby departing from the protective scope of the present invention.

In the above described second embodiment of the invention, the multiple socket may be used by simply resting it on the work surface, if necessary suitably weighting the bottom element 2 so as to provide the multiple socket with greater stability. The individual elements 2 may also assume different ornamental shapes in order to provide the multiple socket with a pleasing and original aesthetic appearance.

The present invention has been described with particular reference to preferred embodiments thereof, but it is obvious that many variations may be made thereto, within the reach of a person skilled in the art, without thereby departing from the protective scope of the invention as defined in the accompanying claims.

1) Multiple mobile power socket, of the type comprising a plurality of individual electric outlets (S, I) which are housed in a single support (1) provided with a cable (C) and plug (P) for supplying electric power to said outlets, characterized in that said support consists of several elements (2) which are hinged on the same axis (a), each element (2) being freely rotatable with respect to the adjacent elements (2) and in that each of said elements (2) houses at least one of said individual electric outlets (S, I).

2) Multiple mobile power socket according to claim 1, wherein said axis (a) passes along internal, and preferably central, position of said elements (2) and said individual electric outlets (S, I) are housed at the sides of said elements (2) which lie parallel or substantially parallel to said axis (a).

3) Multiple mobile power socket according to claim 1, wherein said axis (a) passes along a peripheral position of said elements (2) and said individual electric outlets (S, I) are housed at the sides of said elements (2) which lie parallel and/or perpendicular, or substantially so, to said axis (a).

4) Multiple mobile power socket according to any one of claims 1 to 3, in which each of said elements (2) houses a pair of opposite outlets (S, I).

5) Multiple mobile power socket according to claim 3, wherein each of said elements (2) houses two pairs of opposite outlets (S, I).

6) Multiple mobile power socket according to any one of claims 2 to 5, wherein said elements (2) are substantially cube-shaped.

7) Multiple mobile power socket according to claim 3 or 4, wherein said elements (2) have a substantially straight cylinder shape and said axis (a) is substantially tangential to the side surface of said cylinder and parallel to the generatrices thereof.

8) Multiple mobile power socket according to claim 6 or 7, wherein said axis (a) is in the form of a hollow pin.

9) Multiple mobile power socket according to claim 8, wherein the flexible cables supplying power to said outlets (S, I) pass inside said hollow pin.

10) Multiple mobile power socket according to any one of the preceding claims, further comprising a hooking device (4) for fixing said multiple socket underneath a work surface.

11) Multiple mobile power socket according to claim 10), wherein said hook (4) is located at the top end of the multiple socket and is in the form of a C-shaped hook with elongated arms, apt to elastically clamp the edge of a work surface.

12) Multiple mobile power socket according to any one of the preceding claims, also comprising a bottom element (2) which is weighted and has a flat bottom surface for resting the multiple socket on a work surface.
